(19) United States
(12) Patent Application Publication
(10) Pub. No.: US 2024/0213468 A1
(43) Pub. Date: Jun. 27, 2024

(54) POSITIVE ELECTRODE ACTIVE MATERIAL, POSITIVE ELECTRODE MATERIAL, POSITIVE ELECTRODE LAYER, SOLID-STATE BATTERY, AND METHOD OF PRODUCING SOLID-STATE BATTERY

(71) Applicant: TOYOTA JIDOSHA KABUSHIKI KAISHA, Toyota-chi (JP)

(72) Inventor: Issei SUGIYAMA, Susono-shi (JP)

(73) Assignee: TOYOTA JIDOSHA KABUSHIKI KAISHA, Toyota-shi (JP)

(21) Appl. No.: 18/386,449

(22) Filed: Nov. 2, 2023

(30) Foreign Application Priority Data
Dec. 23, 2022 (JP) 2022-207674

(51) Int. Cl. H01M 4/525; H01M 4/38; H01M 4/505; H01M 10/052

(52) U.S. Cl. CPC H01M 4/525; H01M 4/381; H01M 4/505; H01M 10/052; H01M 2004/028

(57) ABSTRACT

A positive electrode active material includes a lithium complex oxide having at least one type of structure selected from an O2 structure, a T#2 structure, or an O6 structure. When a total content of metals other than Li and Na is 1, the content of Li is from 0.90 to 1.04, and in a case in which a ratio of a minimum value Iₘᵢₙ to a maximum value Iₘₐₓ of luminances at local maximums of three consecutive peaks in one-dimensional luminance spectra is calculated in a total of 75 cases, the rate at which the ratio of the minimum value Iₘᵢₙ to the maximum value Iₘₐₓ is 0.3 or less is 2 or fewer among the 75 cases.

### CROSS-REFERENCE TO RELATED APPLICATION

This application is based on and claims priority under 35 USC 119 from Japanese Patent Application No. 2022-207674 filed on Dec. 23, 2022, the disclosure of which is incorporated by reference herein.

### BACKGROUND

### Technical Field

The present disclosure relates to a positive electrode active material, a positive electrode material, a positive electrode layer, a solid-state battery, and a method of producing a solid-state battery.

### Related Art

A positive electrode active material including a lithium complex oxide having an O2 structure is stable up to a high potential, and thus has a large charge/discharge capacity when it is charged/discharged in a high potential region.

Japanese Patent Application Laid-open (JP-A) No. 2014-186937 proposes a positive electrode active material for use in a non-aqueous electrolyte secondary battery, wherein the positive electrode active material has a layered structure and includes a lithium-containing transition metal oxide in which a main arrangement of a transition metal, oxygen, and lithium is represented by an O2 structure, the lithium-containing transition metal oxide has Li, Mn, and an element M in a lithium-containing transition metal layer in the layered structure and represented by the general composition formula Liₓ[Li_{α}(MnₐM_{b})_{1-α}]O₂, where 0.5<x<1.1, 0.1<α<0.33, 0.67<a<0.97, and 0.03<b<0.33, and M includes at least one or more elements selected from the group consisting of Ni, Mg, Ti, Fe, Sn, Zr, Nb, Mo, W, and Bi.”

Furthermore, JP-A No. 2010-92824 proposes a positive electrode active material for a non-aqueous electrolyte secondary battery, wherein the electric potential P (V) of a lithium-containing layered oxide LiₐN_{ab}M_{c}O_{2±α} (0.5≤a≤1.3, 0≤b≤0.01, 0.90≤c≤1.10, 0≤α≤0.3, and M is at least one element selected from manganese, cobalt, nickel, iron, aluminum, molybdenum, zirconium, or magnesium) belonging to the space group P6₃mc is in the range of 4.8≤P≤5.0 (vs. Li/Li+), a and c represent the molar ratios of lithium and M, respectively, and the ratio of a when c is assumed to be 1.0 is in the range of 0.08≤a≤0.12.

### SUMMARY

Since the stoichiometric composition of a lithium complex oxide having an O2 structure is Li_{2/3}MeO₂ (Me representing a metal element other than Li), the Li amount in the battery is sometimes insufficient, and there is a limit on the magnitude of the charge/discharge capacity.

With respect to this issue, there is a method of pre-doping Li directly into the positive electrode active material to further increase the charge/discharge capacity. However, when this method is used, Li tends to enter also into the transition metal layer of the lithium complex oxide, and the capacity retention rate of the battery tends to decrease when charge and discharge cycles are repeated.

Thus, a problem to be solved by an embodiment of the present disclosure to provide a positive electrode active material with which a battery with a high initial discharge capacity and a high capacity retention rate after repeated charge and discharge cycles can be obtained.

It is a problem to be solved by another embodiment of the present disclosure to provide a positive electrode material with which a battery with a high initial discharge capacity and a high capacity retention rate after repeated charge and discharge cycles can be obtained.

It is a problem to be solved by another embodiment of the present disclosure to provide a positive electrode layer with which a battery with a high initial discharge capacity and a high capacity retention rate after repeated charge and discharge cycles can be obtained.

It is a problem to be solved by another embodiment of the present disclosure to provide a solid-state battery with a high initial discharge capacity and a high capacity retention rate after repeated charge and discharge cycles.

It is a problem to be solved by another embodiment of the present disclosure to provide a method of producing a solid-state battery with which a solid-state battery with a high initial discharge capacity and a high capacity retention rate after repeated charge and discharge cycles can be obtained.

Means for solving the above problems include the following means.

A first aspect of the present disclosure provides a positive electrode active material, including a lithium complex oxide having at least one type of structure selected from an O2 structure, a T#2 structure, or an O6 structure, wherein
when the total content of metals other than Li and Na is 1, the content of Li is from 0.90 to 1.04, and
in a case in which a ratio of a minimum value Iₘᵢₙ to a maximum value Iₘₐₓ of luminances at local maximums of three consecutive peaks in one-dimensional luminance spectra is calculated in a total of 75 cases, the rate at which the ratio of the minimum value Iₘᵢₙ to the maximum value Iₘₐₓ is 0.3 or less is 2 or fewer among the 75 cases.

A second aspect of the present disclosure provides the positive electrode active material according to the first aspect, wherein the positive electrode active material is a compound represented by the following Formula 1:

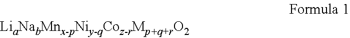

wherein, in Formula 1, a, b, x, y, z, p, q, and r are numbers satisfying 0.9≤a≤1.04, 0≤b≤0.05, x+y+z=1, and 0≤p+q+r≤0.20, and M represents at least one selected from the group consisting of B, Mg, Al, K, Ca, Ti, Cr, Ga, Zr, Nb, Mo, and W.

A third aspect of the present disclosure provides the positive electrode active material of the first or second aspect, wherein in X-ray diffraction measurement the ratio of an intensity I_{Lo} of a peak present in a 2θ range of from 17° to less than 18° to an intensity I_{Hi} of a peak present in a 2θ range of from 18° to less than 19° is less than 5.

A fourth aspect of the present disclosure provides a positive electrode material, the positive electrode material including the positive electrode active material of any one of the first to third aspects.

A fifth aspect of the present disclosure provides a positive electrode layer, the positive electrode layer including the positive electrode material of the fourth aspect.

A sixth aspect of the present disclosure provides a solid-state battery, the solid-state battery including the positive electrode active material of any one of the first to third aspects.

A seventh aspect of the present disclosure provides a method of producing a solid-state battery, the method including:
a step of discharging a battery, the battery including a positive electrode layer, a separator, and a negative electrode layer, the positive electrode layer including a lithium complex oxide having at least one type of structure selected from an O2 structure, a T#2 structure, or an O6 structure, and the negative electrode layer including metallic lithium; and
a step of removing the positive electrode layer from the battery and stacking the removed positive electrode layer, an electrolyte layer or a separator, and a negative electrode layer in this order.

According to an embodiment of the present disclosure, there can be provided a positive electrode active material with which a battery with a high initial discharge capacity and a high capacity retention rate after repeated charge and discharge cycles can be obtained.

According to another embodiment of the present disclosure, there can be provided a positive electrode material with which a battery with a high initial discharge capacity and a high capacity retention rate after repeated charge and discharge cycles can be obtained.

According to another embodiment of the present disclosure, there can be provided a positive electrode layer with which a battery with a high initial discharge capacity and a high capacity retention rate after repeated charge and discharge cycles can be obtained.

According to another embodiment of the present disclosure, there can be provided a solid-state battery with a high initial discharge capacity and a high capacity retention rate after repeated charge and discharge cycles.

According to another embodiment of the present disclosure, there can be provided a method of producing a solid-state battery with which a solid-state battery with a high initial discharge capacity and a high capacity retention rate after repeated charge and discharge cycles can be obtained.

### BRIEF DESCRIPTION OF THE DRAWING

FIG. 1 is a schematic sectional view showing an example of a solid-state battery.

### DETAILED DESCRIPTION

Exemplary embodiments of the present disclosure will be described below. The description and Examples are merely illustrative of the embodiments and are not intended to limit the scope of the invention.

When numerical ranges are given gradationally in the present specification, the upper limit value or the lower limit value given for one numerical range may be replaced with the upper limit value or the lower limit value of another gradationally given numerical range. Furthermore, when numerical ranges are given in the present specification, the upper limit values or the lower limit values of those numerical ranges may be replaced with values described in the Examples.

Reference to a particular component in the present specification may encompass a case in which there are two or more substances that correspond to the component.

When plural substances corresponding to a particular component are present in a composition, the amount of the component in a composition indicated in the present specification refers to the total amount of the plural substances present in the composition unless otherwise specified.

The term “step” includes not only an independent step but also a step that is not clearly distinct from other steps, as long as the desired actions of the step of interest is achieved.

### Positive Electrode Active Material

The positive electrode active material according to the present disclosure includes a lithium complex oxide having at least one type of structure selected from an O2 structure, a T#2 structure, or an O6 structure, wherein, when the total content of metals other than Li and Na is 1, the content of Li is from 0.90 to 1.04, and in a case in which a ratio of a minimum value Iₘᵢₙ to a maximum value Iₘₐₓ of luminances at local maximums of three consecutive peaks in one-dimensional luminance spectra is calculated in a total of 75 cases, the rate at which the ratio of the minimum value Iₘᵢₙ to the maximum value Iₘₐₓ is 0.3 or less is 2 or fewer among the 75 cases.

By virtue of having the above configuration, the positive electrode active material according to the present disclosure is a positive electrode active material with which a battery with a high initial discharge capacity and a high capacity retention rate after repeated charge and discharge cycles can be obtained. We surmise that the reasons therefor are as follows.

The positive electrode active material according to the present disclosure includes a lithium complex oxide having at least one type of structure selected from an O2 structure, a T#2 structure, or an O6 structure. Additionally, the positive electrode active material according to the present disclosure includes a content of Li of from 0.90 to 1.04 when the total content of metals other than Li and Na is 1. Because of this, the Li amount in the composition of the positive electrode active material is high, and the charge/discharge capacity is large. Furthermore, the positive electrode active material according to the present disclosure has a configuration in which in a case in which a ratio of a minimum value Iₘᵢₙ to a maximum value Iₘₐₓ of luminances at local maximums of three consecutive peaks in one-dimensional luminance spectra is calculated in a total of 75 cases, the rate at which the ratio of the minimum value Iₘᵢₙ to the maximum value Iₘₐₓ is 0.3 or less is 2 or fewer among the 75 cases. Since this configuration is adopted, the Li amount in the transition metal layer in the crystalline structure of the positive electrode active material is small. When the Li amount in the transition metal layer in the crystalline structure of the positive electrode active material is so small, the capacity retention rate after repeated charge and discharge cycles tends to become high. For that reason, the positive electrode active material according to the present disclosure has a high capacity retention rate even after repeated charge and discharge cycles.

The positive electrode active material according to the present disclosure will be described below.

### Lithium Complex Oxide

The positive electrode active material according to the present disclosure includes a lithium complex oxide having at least one type of structure selected from an O2 structure, a T#2 structure, or an O6 structure.

Here, the O2 structure is a structure that belongs to the space group P6₃mc and in which lithium is present in the center of an oxygen octahedron and there are two ways of stacking of oxygen and the transition metal in a unit lattice.

The T#2 structure is a structure that belongs to the space group Cmca and in which lithium is present in the center of an oxygen tetrahedron and there are two types of stacking of oxygen and the transition metal in a unit lattice.

The O6 structure is a structure that belongs to the space group R-3m and in which lithium is present in the center of an oxygen octahedron and there are six types of stacking of oxygen and the transition metal in a unit lattice.

### Content of Li

In the positive electrode active material according to the present disclosure, the content of Li is from 0.90 to 1.04 when the total content of metals other than Li and Na is 1.

From the standpoint of the charge/discharge capacity, when the total content of metals other than Li and Na is 1, the content of Li is preferably from 0.93 to 1.03, more preferably from 0.95 1.02, and even more preferably from 0.98 1.01.

The total content of metals other than Li and Na and the content of Li are measured by ICP emission spectroscopy. As the spectrometer used in ICP emission spectroscopy, for example, the product Ultima Expert made by Horiba, Ltd. can be used.

The procedure for measuring the total content of metals other than Li and Na and the content of Li is as follows.

About 10 mg of the positive electrode active material is weighed and dissolved in an acid. For the acid, sulfuric acid is used in a case in which the following Formula 1 is p+q+r=0. In other cases, nitric acid, hot concentrated sulfuric acid, or aqua regia, for example, is used in accordance with the contained elements. The solution obtained by dissolving the positive electrode active material in the acid is introduced to an ICP-AES spectrometer to obtain the mass of each element contained in the solution. Assuming that x+y+z=1, the mass values obtained are converted to the contents of respective metals other than Li and Na. The conversion to the contents of Li and Na is also performed under the above assumption.

### Ratio of Minimum Value Iₘᵢₙ to Maximum Value Iₘₐₓ

In the positive electrode active material according to the present disclosure, in a case in which a ratio of a minimum value Iₘᵢₙ to a maximum value Iₘₐₓ of luminances at local maximums of three consecutive peaks in one-dimensional luminance spectra is calculated in a total of 75 cases, the rate at which the ratio of the minimum value Iₘᵢₙ to the maximum value Iₘₐₓ is 0.3 or less is 2 or fewer among the 75 cases. The luminance at the local maximum of a peak correlates to the amount of the transition metal included at the measured site. Consequently, the larger the amount of transition metal that is present at the atom site at which a peak is observed, the greater the luminance at the local maximum. Further, the larger the amount of Li that is present at the atom site at which a peak is observed, the smaller the luminance at the local maximum. Usually, in a layered compound including Li in a transition metal layer, sites that include Li in a high amount and sites that include virtually no Li are periodically arrayed. The ratio of the minimum value Iₘᵢₙ to the maximum value Iₘₐₓ of luminances at local maximums of three consecutive peaks is smaller in a case in which there is a site including a high amount of Li among the sites corresponding to the three peaks, and the ratio is larger in a case in which there is not.

The minimum value Iₘᵢₙ and the maximum value Iₘₐₓ are measured using a transmission electron microscope. As the transmission electron microscope, the product JEM-ARM200F made by JEOL, Ltd. can be used. A procedure for measuring the ratio of the minimum value Iₘᵢₙ to the maximum value Iₘₐₓ will be described below.

High-angle annular dark-field scanning transmission electron microscope (HAADF-STEM) images acquired at a resolution of 512 or higher in both vertical and horizontal directions are obtained in regard to a 10 nm×10 nm region of a surface of the positive electrode active material at an acceleration voltage of 200 kV, an electron beam incident direction of <1-10>, and a resolution of 0.2 nm or lower. A total of five HAADF-STEM images are obtained, one each from five separate positive electrode active material specimens. For each of the HAADF-STEM images, three one-dimensional luminance spectra are obtained by performing integration over 0.47 nm in the direction in freely-selected three regions not including lattice defects in one or more dimensions, such as dislocations, stacking faults, pores, and grain boundaries. Since there are five HAADF-STEM images, a total of 15 one-dimensional luminance spectra are obtained.

In any one one-dimensional luminance spectrum, the luminances at local maximums of peaks that are present at a frequency 0.2 nm or less is acquired in regard to three consecutive peaks. It will be noted that if peaks at a frequency of 0.2 nm or less are not present, a total of three luminances, the luminances of two adjacent peaks and the luminance at a midpoint between the two peaks, are acquired. The maximum value of the three acquired luminances is taken as maximum value Iₘₐₓ, and the minimum value of the three acquired luminances is taken as minimum value Iₘᵢₙ. Then, the ratio of the minimum value Iₘᵢₙ to the maximum value Iₘₐₓ (minimum value Iₘᵢₙ/maximum value Iₘₐₓ) is calculated. The same procedure is used to calculate the ratio of the minimum value Iₘᵢₙ to the maximum value Iₘₐₓ (minimum value Iₘᵢₙ/maximum value Iₘₐₓ) in different regions in the same one-dimensional luminance spectrum, and a total of 5 ratios of the minimum value Iₘᵢₙ to the maximum value Iₘₐₓ (minimum value Iₘᵢₙ/maximum value Iₘₐₓ) are calculated per one one-dimensional luminance spectrum.

For the remaining one-dimensional luminance spectra also, the same procedure is used to calculate a total of 5 ratios of the minimum value Iₘᵢₙ to the maximum value Iₘₐₓ (minimum value Iₘᵢₙ/maximum value Iₘₐₓ) per one one-dimensional luminance spectrum. A total of 75 ratios of the minimum value Iₘᵢₙ to the maximum value Iₘₐₓ (minimum value Iₘᵢₙ/maximum value Iₘₐₓ) are calculated. It is checked whether or not, among the calculated ratios, the rate at which the ratio of the minimum value Iₘᵢₙ to the maximum value Iₘₐₓ is 0.3 or less is 2 or fewer among the 75 ratios.

The above rate is preferably 1 or fewer among the 75 ratios and more preferably 0 among the 75 ratios.

### Composition Formula of Positive Electrode Active Material

From the standpoint of the initial discharge capacity and the capacity retention rate, it is preferred that the positive electrode active material according to the present disclosure be a compound represented by the following Formula 1.

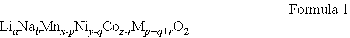

In Formula 1 above, a, b, x, y, z, p, q, and r are numbers satisfying 0.9≤a≤1.04, 0≤b≤0.05 (preferably 0≤b≤0.03), x+y+z=1, and 0≤p+q+r≤0.20 (preferably 0≤p+q+r≤0.10), and M represents at least one selected from the group consisting of B, Mg, Al, K, Ca, Ti, Cr, Ga, Zr, Nb, Mo, and W.

M represents at least one selected from the group consisting of B, Mg, Al, K, Ca, Ti, Cr, Ga, Zr, Nb, Mo, and W.

x is preferably a number that satisfies 0≤x≤1 and more preferably a number that satisfies 0.1<x≤1.

y is preferably a number that satisfies 0≤y≤0.5 and more preferably a number that satisfies 0≤y≤0.33.

z is preferably a number that satisfies 0≤z≤1 and more preferably a number that satisfies 0≤z≤0.67.

p is preferably a number that satisfies 0≤p≤0.10.

q is preferably a number that satisfies 0≤q≤0.10.

r is preferably a number that satisfies 0≤r≤0.10.

### Intensity I_{Hi} and Intensity I_{Lo}

From the standpoint of the initial discharge capacity and the capacity retention rate, in X-ray diffraction measurement the ratio of an intensity I_{Lo} of a peak present in a 2θ range of from 17° to less than 18° to an intensity I_{Hi} of a peak present in a 2θ range of from 18° to less than 19° is preferably 5 or less, more preferably 3 or less, and even more preferably 2 or less.

The intensity I_{Hi} and the intensity I_{Lo} are measured in X-ray diffraction measurement. As the X-ray diffractometer, the product RINT-2000 made by Rigaku Corporation can be used. A procedure for measuring the intensity I_{Hi} and the intensity I_{Lo} will be described below.

X-ray diffraction measurement is performed at a step of 0.01° and at least 0.1 sec/step so that the 2θ range covers at least the range of from 10° to less than 20°. In the results of the X-ray diffraction measurement, the maximum intensity of a peak having a maximum intensity among peaks that are in a range of from 17° to less than 18° is taken as I_{Lo}, and the maximum intensity of a peak having a maximum intensity among peaks that are in a range of from 18° to less than 19° in the same measurement results is taken as I_{Hi}.

### Specific Examples of Positive Electrode Active Material

Specific examples of the positive electrode active material according to the present disclosure include Li_{1.0}Na_{0.0}Mn_{0.5}Ni_{0.2}Co_{0.3}O₂, Li_{1.0}Na_{0.0}Mn_{0.4}Ni_{0.2}Co_{0.3}Cr_{0.1}O₂, Li_{1.0}Na_{0.0}Mn_{0.67}Ni_{0.33}Co_{0.0}O₂, Li_{0.95}Na_{0.05}Mn_{0.5}Ni_{0.2}Co_{0.3}O₂, Li_{1.04}Na_{0.00}Mn_{0.5}Ni_{0.2}Co_{0.3}O₂, and Li_{1.0}Na_{0.0}Mn_{0.5}Ni_{0.1}Co_{0.3}Mg_{0.1}O₂.

### Positive Electrode Material

The positive electrode material according to the present disclosure contains a positive electrode active material and may also contain a conductive additive, a solid electrolyte, a binder, and other components as needed.

### Positive Electrode Active Material

As the positive electrode active material included in the positive electrode material according to the present disclosure, the positive electrode active material according to the present disclosure is applied, and preferred aspects thereof are also the same.

The positive electrode active material included in the positive electrode material according to the present disclosure may also contain another positive electrode active material other than the positive electrode active material according to the present disclosure.

The other positive electrode active material preferably includes a lithium complex oxide. The lithium complex oxide may contain at least one selected from the group consisting of F, Cl, N, S, Br, and I. Furthermore, the lithium complex oxide may have a crystalline structure belonging to at least one space group selected from the space groups R-3m, Immm, or P63-mmc (also called P63mc and P6/mmc). Furthermore, the main array of the transition metal, oxygen, and lithium in the lithium complex oxide may have an O2 structure.

Examples of lithium complex oxides having a crystalline structure belonging to R-3m include compounds represented by LiₓMe_{y}O_{α}X_{β} wherein Me represents at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si, and P, X represents at least one selected from the group consisting of F, Cl, N, S, Br, and I, and x, y, α, and β satisfy 0.5≤x≤1.5, 0.5≤y≤1.0, 1≤α<2, and 0<β≤1.

Examples of lithium complex oxides having a crystalline structure belonging to Immm include complex oxides represented by Liₓ₁M¹A¹₂ (wherein x1 satisfies 1.5≤x1≤2.3, M¹ includes at least one selected from the group consisting of Ni, Co, Mn, Cu, and Fe, and A¹ includes at least oxygen, and the proportion of oxygen in A¹ is 85 at % or more) (a specific example is Li₂NiO₂) and complex oxides represented by Liₓ₁M^{1A}₁₋ₓ₂M^{1B}ₓ₂O_{2-y}A²_{y} (wherein 0≤x2≤0.5 and 0≤y≤0.3 and at least one of x2 or y is not 0, M^{1A} represents at least one selected from the group consisting of Ni, Co, Mn, Cu, and Fe, M^{1B} represents at least one selected from the group consisting of Al, Mg, Sc, Ti, Cr, V, Zn, Ga, Zr, Mo, Nb, Ta, and W, and A² represents at least one selected from the group consisting of F, Cl, Br, S, and P).

Examples of lithium complex oxides having a crystalline structure belonging to P63-mmc include complex oxides represented by M1ₓM2_{y}O₂ wherein M1 represents an alkali metal (preferably at least one of Na or K), M2 represents a transition metal (preferably at least one selected from the group consisting of Mn, Ni, Co, and Fe), and x+y satisfies 0<x+y≤2.

Examples of lithium complex oxides having an O2 structure include complex oxides represented by Liₓ[Li_{α}(MnₐCo_{b}M_{c})_{1-α}]O₂ wherein x, α, a, b, and c satisfy 0.5<x<1.1, 0.1<α<0.33, 0.17<a<0.93, 0.03<b<0.50, 0.04<c<0.33, and M represents at least one selected from the group consisting of Ni, Mg, Ti, Fe, Sn, Zr, Nb, Mo, W, and Bi, and specific examples thereof include Li_{0.744}[Li_{0.145}Mn_{0.625}Co_{0.115}Ni_{0.115}]O₂.

An aspect in which at least part of the surface of the positive electrode active material is coated with a sulfide solid electrolyte, an oxide solid electrolyte, or a halide solid electrolyte is more preferred. As the halide solid electrolyte for coating at least part of the surface of the positive electrode active material, Li_{6-(4-x)b}(Ti₁₋ₓAlₓ)_{b}F₆ (0<x<1 and 0<b≤1.5) [LTAF electrolyte] is preferred.

### Conductive Additive

Examples of conductive additives include carbon materials, metal materials, and conductive polymer materials. Examples of carbon materials include carbon black (e.g., acetylene black, furnace black, Ketjen black), fibrous carbon (e.g., vapor-grown carbon fibers, carbon nanotubes, carbon nanofibers), graphite, and carbon fluoride. Examples of metal materials include metal powders (e.g., aluminum powder), conductive whiskers (e.g., zinc oxide, potassium titanate), and conductive metal oxides (e.g., titanium oxide). Examples of conductive polymer materials include polyaniline, polypyrrole, and polythiophene. Just one conductive additive may be used by itself, or two or more conductive additives may be mixed together and used.

### Solid Electrolyte

It is preferred that the solid electrolyte include at least one solid electrolyte species selected from the solid electrolyte group consisting of a sulfide solid electrolyte, an oxide solid electrolyte, and a halide solid electrolyte.

The sulfide solid electrolyte contains sulfur (S) as the main anion element and also, for example, preferably contains an Li element and an A element. The A element is at least one selected from the group consisting of P, As, Sb, Si, Ge, Sn, B, Al, Ga, and In. The sulfide solid electrolyte may further contain at least one of O or a halogen element. Examples of the halogen element (X) include F, Cl, Br, and I. The composition of the sulfide solid electrolyte is not particularly limited, and examples include xLi₂S·(100-x)P₂S₅ (70≤x≤80) and yLiI·zLiBr·(100-y-z)(xLi₂S·(1-x)P₂S₅) (0.7≤x≤0.8, 0≤y≤30, 0≤z≤30). The sulfide solid electrolyte may have the composition represented by the following General Formula (1).

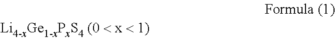

In Formula (1), at least part of Ge may be substituted with at least one selected from the group consisting of Sb, Si, Sn, B, Al, Ga, In, Ti, Zr, V, and Nb. Furthermore, at least part of P may be substituted with at least one selected from the group consisting of Sb, Si, Sn, B, Al, Ga, In, Ti, Zr, V, and Nb. Part of Li may be substituted with at least one selected from the group consisting of Na, K, Mg, Ca, and Zn. Part of S may be substituted with a halogen. The halogen is at least one of F, Cl, Br, or I.

The oxide solid electrolyte contains oxygen (O) as the main anion element, and may contain an Li element and a Q element (Q representing at least one of Nb, B, Al, Si, P, Ti, Zr, Mo, W, or S). Examples of oxide solid electrolytes include garnet-type solid electrolytes, perovskite-type solid electrolytes, NASICON-type solid electrolytes, Li—P—O-based solid electrolytes, and Li—B—O-based solid electrolytes. Example of garnet-type solid electrolytes include Li₇La₃Zr₂O₁₂, Li₇₋ₓLa₃(Zr₂₋ₓNbₓ)O₁₂ (0≤x≤2), and Li₅La₃Nb₂O₁₂. Examples of perovskite-type solid electrolytes include (Li, La)TiO₃, (Li, La)NbO₃, and (Li, Sr)(Ta, Zr)O₃. Examples of NASICON-type solid electrolytes include Li(Al, Ti)(PO₄)₃ and Li(Al, Ga)(PO₄)₃. Examples of Li—P—O-based solid electrolytes include Li₃PO₄ and LIPON (a compound in which part of O in Li₃PO₄ is substituted with N), and examples of Li—B—O-based solid electrolytes include Li₃BO₃ and compounds obtained by substituting part of O in Li₃BO₃ with C.

As the halide solid electrolyte, a solid electrolyte including Li, M, and X (M representing at least one of Ti, Al, or Y, and X representing F, Cl, or Br) is preferred. Specifically, Li_{6-3z}Y_{z}X₆ (in which X represents Cl or Br, and z satisfies 0<z<2) and Li_{6-(4-x)b}(Ti₁₋ₓAlₓ)_{b}F₆ (in which 0<x<1, 0<b≤1.5) are preferred. Among Li_{6-3z}Y_{z}X₆, in terms of having superior lithium ion conductivity, Li₃YX₆ (in which X represents Cl or Br) is more preferred, and Li₃YCl₆ is even more preferred. Furthermore, it is preferred that Li_{6-(4-x)b}(Ti₁₋ₓAlₓ)_{b}F₆ (0<x<1, 0<b≤1.5) be included together with a solid electrolyte such as a sulfide solid electrolyte from the standpoint of inhibiting oxidative decomposition of the sulfide solid electrolyte.

### Binder

Examples of binders include vinyl halide resins, rubbers, and polyolefin resins. Examples of vinyl halide resins include polyvinylidene fluoride (PVdF) and a copolymer of polyvinylidene fluoride and hexafluoropropylene (PVdF-HFP). Examples of polyolefin resins include butadiene rubber (BR), acrylate-butadiene rubber (ABR), styrene-butadiene rubber (SBR), acrylonitrile-butadiene rubber (NBR), and butyl rubber (isobutylene-isoprene rubber). Examples of polyolefin resins include polyethylene and polypropylene. The binder may be a diene-based rubber including a double bond in its main chain, such as a butadiene-based rubber in which butadiene occupies 30 mol % or more of the entire rubber.

### Other Components

Examples of other components include oxide solid electrolytes, halide solid electrolytes, thickeners, surfactants, dispersants, wetting agents, antifoaming agents, and solvents.

### Solid-State Battery

The solid-state battery according to the present disclosure includes the positive electrode active material according to the present disclosure.

The solid-state battery according to the present disclosure preferably includes a positive electrode layer, a negative electrode layer, and an electrolyte layer or a separator disposed between the positive electrode layer and the negative electrode layer. The positive electrode layer preferably includes the positive electrode material of the present disclosure.

### Battery Structure

The solid-state battery includes what is called an all-solid-state battery which uses an inorganic solid electrolyte as the electrolyte (in which the content of the electrolyte solution serving as an electrolyte is less than 10% by mass relative to the total amount of electrolytes).

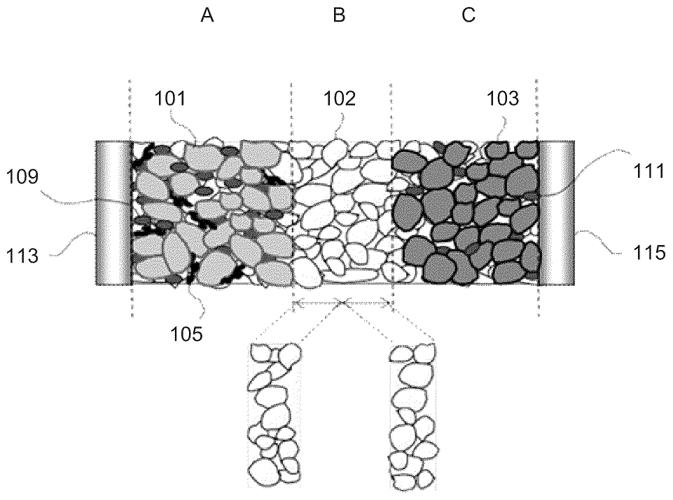

The structure of the solid-state battery of the present disclosure may be a structure including a positive electrode current collector, a positive electrode layer, a solid electrolyte layer, a negative electrode layer, and a negative electrode current collector in this order, and, for example, may be the structure shown in FIG. 1. Solid electrolyte layer B in FIG. 1 may have a two-layer structure. FIG. 1 is a schematic sectional view showing an example of a solid-state battery. The solid-state battery shown in FIG. 1 includes a negative electrode, which includes a negative electrode current collector 113 and a negative electrode layer A, a solid electrolyte layer B, and a positive electrode, which includes a positive electrode current collector 115 and a positive electrode layer C. The negative electrode layer A includes a negative electrode active material 101, a conductive additive 105, a binder 109, and a solid electrolyte 102. The positive electrode layer C includes a positive electrode active material 103, a binder 111, and the solid electrolyte 102.

When a set of the positive electrode layer, the solid electrolyte layer, and the negative electrode layer serves as a power generation unit, the solid-state battery may have just one or may have two or more power generation units. When the solid-state battery has two or more power generation units, those power generation units may be connected in series or in parallel.

The solid-state battery may be configured by sealing, with resin, stack edge faces (side faces) of a stacked structure of the positive electrode layer/the solid electrolyte layer/the negative electrode layer. The current collectors of the electrodes may have a configuration in which a buffer layer, an elastic layer, or a positive temperature coefficient (PTC) thermistor layer is disposed on the surface.

The shape of the solid-state battery is not particularly limited and, for example, may be coin-shaped, cylindrical, rectangular, sheet-shaped, button-shaped, flat-shaped, or stacked.

### Electrolyte Layer and Separator

The solid-state battery includes an electrolyte layer or a separator.

The electrolyte layer may be a layer including a solid electrolyte.

When the electrolyte layer is a layer including a solid electrolyte (a solid electrolyte layer), the solid electrolyte layer preferably includes one selected from the group consisting of a sulfide solid electrolyte, an oxide solid electrolyte, and a halide solid electrolyte.

As specific examples of the sulfide solid electrolyte, the oxide solid electrolyte, and the halide solid electrolyte, the same ones as those described above are applied.

The solid electrolyte layer may have a single-layer structure or a multi-layer structure comprising two or more layers.

The solid electrolyte layer may or may not include a binder. As examples of the binder that can be included in the solid electrolyte layer, the same binders as those described above are applied.

As the separator, a porous sheet (film) formed from a resin such as polyethylene (PE), polypropylene (PP), polyester, cellulose, or polyamide can be used.

### Positive Electrode Layer

The solid-state battery includes a positive electrode layer. The positive electrode layer includes the positive electrode material of the present disclosure.

### Positive Electrode Current Collector

The solid-state battery may further include a positive electrode current collector. The positive electrode current collector collects current for the positive electrode layer. The positive electrode current collector is disposed at a position at a side opposite to the solid electrolyte layer in relation to the positive electrode layer.

Examples of positive electrode current collectors include stainless steel, aluminum, copper, nickel, iron, titanium, and carbon, with aluminum alloy foil or aluminum foil being preferred. Aluminum alloy foil and aluminum foil may be produced using powder. The shape of the positive electrode current collector is, for example, foil-shape or mesh-shape.

The positive electrode current collector may have a configuration in which a buffer layer, an elastic layer, or a positive temperature coefficient (PTC) thermistor layer is disposed on the surface.

### Negative Electrode Layer

The solid-state battery includes a negative electrode layer. The negative electrode layer contains a negative electrode active material. The negative electrode layer may contain at least one of a solid electrolyte for a negative electrode, a conductive additive, and a binder as needed. Examples of negative electrode active materials include Li-based active materials such as metallic lithium, carbon-based active materials such as graphite, oxide-based active materials such as lithium titanate, and Si-based active materials such as simple Si. Examples of the conductive additive, the solid electrolyte for a negative electrode, and the binder used in the negative electrode layer include the same ones as the foregoing examples given for the conductive additive included in the positive electrode layer, the solid electrolyte included in the solid electrolyte layer, and the binder.

### Negative Electrode Current Collector

The solid-state battery may further include a negative electrode current collector. The negative electrode current collector collects current for the negative electrode layer. The negative electrode current collector is disposed at a position at a side opposite to the solid electrolyte layer in relation to the negative electrode layer.

Examples of negative electrode current collectors include stainless steel, aluminum, copper, nickel, iron, titanium, and carbon, with copper being preferred. The shape of the negative electrode current collector is, for example, foil-shape or mesh-shape.

The negative electrode current collector may have a configuration in which a buffer layer, an elastic layer, or a positive temperature coefficient (PTC) thermistor layer is disposed on the surface.

### Method of Producing Solid-State Battery

A method of producing a solid-state battery according to the present disclosure includes:
a step (doping step) of discharging a battery, the battery including a positive electrode layer including a lithium complex oxide having at least one type of structure selected from an O2 structure, a T#2 structure, or an O6 structure and a negative electrode layer including metallic lithium; and
a step (stacking step) of removing the positive electrode layer from the battery and stacking the removed positive electrode layer, an electrolyte layer or a separator, and the negative electrode layer in this order.

The method of producing a solid-state battery according to the present disclosure may include other steps in addition to the ones above, such as a step of housing the battery in a case.

### Doping Step

The doping step is a step of discharging a battery, the battery including a positive electrode layer including a lithium complex oxide having at least one type of structure selected from an O2 structure, a T#2 structure, or an O6 structure, a separator, and a negative electrode layer including metallic lithium.

### Procedure for Preparing Positive Electrode Layer

A procedure for preparing the positive electrode layer for use in the doping step will be described.

The positive electrode layer for use in the doping step includes a lithium complex oxide having at least one type of structure selected from an O2 structure, a T#2 structure, or an O6 structure, and may also include a conductive additive, a solid electrolyte, a binder, and other components as needed.

It is preferred that the positive electrode layer be prepared by kneading the components that can be contained in the positive electrode layer to obtain a slurry, then applying the slurry to a substrate, drying the slurry to obtain a dry film, and pressing the dry film.

The method of kneading the components that can be contained in the positive electrode layer when obtaining the slurry is not particularly limited, and examples thereof include a method of kneading using a kneading device. Examples of kneading devices include ultrasonic homogenizers, shakers, thin-film rotary mixers, dissolvers, homomixers, kneaders, roll mills, sand mills, attritors, ball mills, vibrator mills, and high-speed impeller mills.

Examples of techniques for pressing the dry film include roll pressing and cold isostatic pressing (CIP).

The pressure during pressing is preferably 0.1 t (ton)/cm² or more, more preferably 0.5 t/cm² or more, and even more preferably 1 t/cm² or more. The pressure during pressing is preferably 10 t/cm² or less, more preferably 8 t/cm² or less, and even more preferably 6 t/cm² or less.

It is preferred that the lithium complex oxide having at least one type of structure selected from an O2 structure, a T#2 structure, or an O6 structure included in the positive electrode layer for use in the doping step be prepared by ion-exchanging Na included in a Na-doped precursor with Li.

Examples of the Na-doped precursor include a sodium complex oxide having a P2 structure belonging to the space group P6₃/mmc.

Examples of the sodium complex oxide include compounds represented by Formula 2 below.

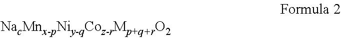

In Formula 2 above, c, x, y, z, p, q, and r are numbers that satisfy 0≤c≤1 (preferably 0.6≤c≤0.9), x+y+z=1, and 0≤p+q+r≤0.20 (preferably 0≤p+q+r≤0.1), and M represents at least one selected from the group consisting of Li, B, Mg, Al, K, Ca, Ti, Cr, Ga, Zr, Nb, Mo, and W.

x is preferably a number that satisfies 0≤x≤1 and more preferably a number that satisfies 0.1≤x≤1.

y is preferably a number that satisfies 0≤y≤0.5 and more preferably a number that satisfies 0≤y≤0.33.

z is preferably a number that satisfies 0≤z≤1 and more preferably a number that satisfies 0≤z≤0.67.

p is preferably a number that satisfies 0≤p≤0.10.

q is preferably a number that satisfies 0≤q≤0.10.

r is preferably a number that satisfies 0≤r≤0.10.

For the ion exchange of the Na-doped precursor, a molten salt bed in which lithium nitrate and lithium chloride are mixed can be used.

The temperature conditions during ion exchange are preferably in a range equal to or higher than the temperature at which the molten salt bed melts but less than 320° C.

### Battery

The battery used in the doping step will now be described.

The battery used in the doping step has the positive electrode layer prepared by the above procedure, a separator, and a negative electrode layer including metallic lithium.

As the separator, a porous sheet (film) formed from a resin such as polyethylene (PE), polypropylene (PP), polyester, cellulose, or polyamide can be used.

The negative electrode layer includes metallic lithium. From the standpoint of increasing the efficiency of the doping step, it is preferred that the negative electrode layer consist of metallic lithium.

The battery used in the doping step may further contain a non-aqueous electrolyte solution. The non-aqueous electrolyte solution is not particularly limited, and conventionally known non-aqueous electrolyte solutions can be used.

The non-aqueous electrolyte preferably contains a non-aqueous solvent and a supporting salt. Examples of non-aqueous solvents include carbonates, such as ethylene carbonate, diethyl carbonate, dimethyl carbonate, and ethyl methyl carbonate, and ethers and esters. Examples of supporting salts include lithium salts such as LiPF₆ and LiBF₄.

Furthermore, the battery used in the doping step preferably further contains a positive electrode current collector.

As the positive electrode current collector, the same positive electrode current collectors as the foregoing positive electrode current collectors applicable to the solid-state battery according to the present disclosure can be applied.

The battery used in the doping step is preferably prepared by stacking the positive current collector, the positive electrode layer, the separator, and the negative electrode layer in this order to obtain an electrode body and then housing the electrode body and the non-aqueous electrolyte solution in a battery case (exterior container).

### Discharge

In the doping step, the battery prepared by the above procedure is discharged.

By discharging the prepared battery, lithium ions are doped from the negative electrode layer into the positive electrode active material, thus increasing the lithium content in the positive electrode active material.

As for the conditions for discharging the battery, for example, it is preferred that the battery be discharged to a voltage of from 1 V to 3 V at a current magnitude of 0.01 C to 0.2 C.

Furthermore, it is preferred that the discharging be performed to maintain a voltage within a range of from 1 V to 3 V, until the final current magnitude of from 0.05 C to 0.02 C.

### Stacking Step

The stacking step is a step of removing the positive electrode layer from the battery and stacking the removed positive electrode layer, an electrolyte layer or a separator, and the negative electrode layer in this order.

### Removal of Positive Electrode Layer

In the stacking step, the positive electrode layer is removed from the battery that has undergone the doping step.

The method of removing the positive electrode layer is not particularly limited, and it is preferred that the positive electrode layer be removed by disassembling the battery.

### Stacking of Positive Electrode Layer, Electrolyte Layer (or Separator), and Negative Electrode Layer

In the stacking step, the removed positive electrode layer, an electrolyte layer or a separator, and the negative electrode layer are stacked in this order.

As the electrolyte layer and the negative electrode layer, the electrolyte layer and the negative electrode layer applied to the solid-state battery according to the present disclosure described above are applied.

The method of preparing the electrolyte layer and the negative electrode layer is not particularly limited, and it is preferred that the electrolyte layer and the negative electrode layer be prepared by kneading the components that can be contained in the electrolyte layer and the negative electrode layer to obtain a slurry, then applying the slurry to a substrate, drying the slurry to obtain a dry film, and pressing the dry film.

As the separator, a commercially available porous sheet (film) can be used.

Then, the removed positive electrode layer, the electrolyte layer or the separator, and the negative electrode layer are stacked in this order and pressed as needed to obtain a stack (electrode body).

It is preferred that the solid-state battery according to the present disclosure be prepared via the above steps.

### EXAMPLES

Examples will be described below, but the present invention is not in any way limited to these Examples. It will be noted that in the following description, “parts” and “%” are all based on mass unless otherwise specified.

### Preparation of Lithium Complex Oxide to be Included in Positive Electrode Layer Used in Doping Step

### Preparation of Lithium Complex Oxide 1

### Preparation of Na-Doped Precursor

Mn(NO₃)₂·6H₂O, Ni(NO₃)₂·6H₂O, and Co(NO₃)₂·6H₂O were used as raw materials and dissolved in pure water so that the molar ratio of Mn, Ni, and Co was 5:2:3. A Na₂CO₃ solution with a concentration of 12% by mass was prepared, and these two solutions were simultaneously added into a beaker. At this time, the addition rate was controlled so that the pH was 7.0 or more but less than 7.1. After the addition was completed, the mixed solution was stirred for 24 hours at 50° C. and 300 rpm. The obtained reaction product was washed with pure water and centrifuged to separate only the precipitated powder. The obtained powder was dried at 120° C. for 48 hours and then pulverized in an agate mortar to obtain a powder.

Na₂CO₃ was added to and mixed with the obtained powder so that the composition ratio was Na_{0.75}Mn_{0.5}Ni_{0.2}Co_{0.3}O₂. The mixed powder was pressed with a load of 2 tons using cold isostatic pressing to prepare pellets. The obtained pellets were pre-fired in the atmosphere at 600° C. for 6 hours and fired at 700° C. for 24 hours, then cooled to 250° C. at 3° C./min, and left to cool, thus synthesizing a Na-doped precursor.

### Preparation of Lithium Complex Oxide

A mixed powder was obtained by mixing LiNO₃ and LiCI at a mass ratio of 88:12. The mixed powder was weighed so that the ratio of the number of moles of Li included in the mixed powder to the number of moles of the Na-doped precursor was 10 times. The Na-doped precursor and the mixed powder were mixed, and ion exchange was performed in the atmosphere at 280° C. for 1 hour. After ion exchange, water was added to dissolve the salt, and washing with water was further performed to obtain a lithium complex oxide 1 having an O2 structure (Li_{0.65}Mn_{0.5}Ni_{0.2}Co_{0.3}O₂).

### Preparation of Lithium Complex Oxide 2

A lithium complex oxide 2 (Li_{0.91}Mn_{0.5}Ni_{0.2}Co_{0.3}O₂) having an O2 structure was obtained by the same procedure as in “(Preparation of Lithium Complex Oxide 1)” except that LiI was used instead of LiCi in “—Preparation of Lithium Complex Oxide—”.

### Preparation of Lithium Complex Oxide 3

A lithium complex oxide 3 (Li_{0.1}Na_{0.75}Mn_{0.55}Ni_{0.1}Co_{0.25}O₂) having an O2 structure was obtained by the same procedure as in “(Preparation of Lithium Complex Oxide 1)” except that “—Preparation of Na-doped Precursor—” was changed in the following way.

### Preparation of Na-Doped Precursor

Mn(NO₃)₂·6H₂O, Ni(NO₃)₂·6H₂O, and Co(NO₃)₂·6H₂O were used as raw materials and dissolved in pure water so that the molar ratio of Mn, Ni, and Co was 55:10:25. A Na₂CO₃ solution with a concentration of 12% by mass was prepared, and these two solutions were simultaneously added into a beaker. At this time, the addition rate was controlled so that the pH was 7.0 or more but less than 7.1. After the addition was completed, the mixed solution was stirred for 24 hours at 50° C. and 300 rpm. The obtained reaction product was washed with pure water and centrifuged to separate only the precipitated powder. The obtained powder was dried at 120° C. for 48 hours and then pulverized in an agate mortar to obtain a powder.

Na₂CO₃ and Li₂CO₃ were added to and mixed with the obtained powder so that the composition ratio was Li_{0.1}Na_{0.75}Mn_{0.55}Ni_{0.1}Co_{0.25}O₂. The mixed powder was pressed with a load of 2 tons using cold isostatic pressing to prepare pellets. The obtained pellets were pre-fired in the atmosphere at 600° C. for 6 hours and fired at 700° C. for 24 hours, then cooled to 250° C. at 3° C./min, and left to cool, thus synthesizing a Na-doped precursor.

### Example 1

### Doping Step

### Preparation of Positive Electrode Layer

85 g of the lithium complex oxide 1 obtained by the above procedure (ball-milled to a powder) and 10 g of carbon black as a conductive additive were introduced to 125 mL of a solution of solvent n-methylpyrrolidone in which 5 g of polyvinylidene fluoride (PVDF) as a binder was dissolved, and the mixture was kneaded until uniformly mixed to prepare a slurry. The slurry was applied at a basis weight of 6 mg/cm² to one side of a 15 μm-thick Al current collector as a substrate and dried to obtain an electrode. Thereafter, the electrode was pressed so that the thickness of the positive electrode layer was 45 μm and the density of the positive electrode layer was 2.4 g/cm³. Finally, the electrode was cut out into a circle having a diameter of 16 mm to obtain a positive electrode including a positive electrode layer and a positive electrode current collector.

### Preparation of Negative Electrode Layer

A negative electrode layer was obtained by cutting out Li foil to a diameter of 19 mm.

### Preparation of Battery

A CR2032 coin cell battery was prepared using the obtained positive electrode and the negative electrode layer. It will be noted that a porous sheet made of PP was used as a separator and that a solution obtained by dissolving lithium hexafluorophosphate (LiPF₆) as a supporting salt at a concentration of 1 mol/L in an ethylene carbonate (EC)/dimethyl carbonate (DMC) mixture with a volume ratio of 3:7 was used as a non-aqueous electrolyte solution.

### Discharge

The prepared battery was discharged to 2.0 V at 0.1 C and was further maintained at 2.0 V until the final current was 0.01 C, thereby performing lithium ion doping. The time required for the discharge was 512 minutes.

### Stacking Step

### Removal of Positive Electrode

After the discharge was performed, the battery was disassembled to remove the positive electrode having the positive electrode layer and the positive electrode current collector.

### Preparation of Separator

A separator was obtained by cutting out a porous sheet made of PP to a diameter of 19 mm as a separator.

### Preparation of Negative Electrode Layer

A negative electrode layer was obtained by cutting out 1-mm-thick Li foil to a diameter of 19 mm.

### Stacking of Positive Electrode Layer, Electrolyte Layer, and Negative Electrode Layer

The removed positive electrode, the separator, and the negative electrode layer were stacked in this order to obtain a stack. It will be noted that the positive electrode was stacked so that the positive electrode layer faced the separator. The stack and a non-aqueous electrolyte solution (a solution obtained by dissolving lithium hexafluorophosphate (LiPF₆) as a supporting salt at a concentration of 1 mol/L in an ethylene carbonate (EC)/dimethyl carbonate (DMC) mixture with a volume ratio of 3:7) were housed in a coin cell to prepare a CR2032 coin cell battery.

### Example 2

A CR2032 coin cell battery was prepared by the same procedure as in Example 1 except that “—Discharge—” in the “(Doping Step)” was changed to the following procedure.

### Discharge

The voltage was swept from the open circuit voltage (OCV) to 1.5 V at a sweep speed of 5 mV/sec and held at 1.5 V for 10 minutes. The time required for the discharge was 16 minutes.

### Comparative Example 1

A positive electrode was prepared by the same procedure as in “—Preparation of Positive Electrode Layer—” in the “(Doping Step)” of Example 1, and a battery was prepared by the same procedure as in the “(Stacking Step)” of Example 1 except that the above positive electrode was used instead of the positive electrode that was removed by disassembling the battery in the “(Stacking Step)”.

### Comparative Example 2

A positive electrode was prepared by the same procedure as in “—Preparation of Positive Electrode Layer—” in the “(Doping Step)” of Example 1 except that the lithium complex oxide 2 was used instead of the lithium complex oxide 1 in the “—Preparation of Positive Electrode Layer—” in the “(Doping Step)” of Example 1, and a battery was prepared by the same procedure as in the “(Stacking Step)” of Example 1 except that the above positive electrode was used instead of the positive electrode that was removed by disassembling the battery in the “(Stacking Step)”.

### Comparative Example 3

A positive electrode was prepared by the same procedure as in “—Preparation of Positive Electrode Layer—” in the “(Doping Step)” of Example 1 except that the lithium complex oxide 3 was used instead of the lithium complex oxide 1 in the “—Preparation of Positive Electrode Layer—” in the “(Doping Step)” of Example 1, and a battery was prepared by the same procedure as in the “(Stacking Step)” of Example 1 except that the above positive electrode was used instead of the positive electrode that was removed by disassembling the battery in the “(Stacking Step)”.

### Evaluation

### Li Content, Minimum Value Iₘᵢₙ/Maximum value Iₘₐₓ, and Intensity I_{Lo}/Intensity I_{Hi}

Table 1 shows results obtained by calculating, in accordance with the procedures described above, the “content of Li (“Li Percentage Content” in Table 1”) when the total content of metals other than Li and Na is 1”, the “rate at which the ratio of the minimum value Iₘᵢₙ to the maximum value Iₘₐₓ is 0.3 or less (“Rate (number) at which Iₘᵢₙ/Iₘₐₓ is 0.3 or less” in Table 1)”, and the “ratio of the intensity I_{Lo} to the intensity I_{Hi} (“Intensity I_{Lo}/Intensity I_{Hi}” in Table 1)” of the positive electrode active material included in the battery obtained in each example.

### Initial Discharge Capacity

A charge/discharge test was implemented using a galvanostat at a current of 0.1 C, an end-of-charge voltage of 4.8 V, and an end-of-discharge voltage of 2.0 V. Charging was performed first, and after a first charging was completed, the amount of current required for discharging to 2.0 V was calculated, and the initial discharge capacity was calculated by dividing the amount of current by the weight of the active material used for measurement.

### Capacity Retention Rate after 20 Cycles

A charge/discharge test was implemented under the same conditions as above, and the discharge capacity obtained in the first charge-discharge cycle and the discharge capacity obtained in the twentieth charge-discharge cycle were calculated. The capacity retention rate after 20 cycles was obtained by dividing the discharge capacity obtained in the twentieth cycle by the discharge capacity in the first cycle.

TABLE 1

| | | | | | | Battery | |
|---|---|---|---|---|---|---|---|
| | Positive Electrode Active Material | | | | | | Capacity |
| | | | | Rate (number) | | Initial | Retention |
| | | | Li | at which Iₘᵢₙ/ | Intensity | Discharge | Rate after |
| | | | Percentage | Iₘₐₓ is 0.3 or | I_{Lo}/ | Capacity | 20 Cycles |
| | Structure | Composition Formula | Content | less | Intensity I_{Hi} | (mAh/g) | (%) |
| Example 1 | O2 | Li_{0.98}Mn_{0.5}Ni_{0.2}CO_{0.3}O₂ | 0.98 | 1 | 0.8 | 221.5 | 96.1 |
| Example 2 | O2 | Li_{0.96}Mn_{0.5}Ni_{0.2}CO_{0.3}O₂ | 0.96 | 0 | 1.2 | 218.3 | 95.5 |
| Comparative | O2 + | Li_{0.65}Mn_{0.5}Ni_{0.2}Co_{0.3}O₂ | 0.65 | 0 | 11 | 151.8 | 92.3 |
| Example 1 | T#2 | | | | | | |
| Comparative | O2 | Li_{0.91}Mn_{0.5}Ni_{0.2}Co_{0.3}O₂ | 0.91 | 58 | 0.6 | 181.4 | 88.1 |
| Example 2 | | | | | | | |
| Comparative | O2 | Li_{1.07}Mn_{0.55}Ni_{0.1}Co_{0.25}O₂ | 1.07 | 21 | 1.6 | 237.5 | 76.8 |
| Example 3 | | | | | | | |

Table 1 shows the structure and composition formula of the positive electrode active material included in the battery obtained in each example.

It will be noted that “O2+T#2” listed in regard to a structure means that the structure has an O2 structure and a T#2 structure.

From the above results, it can be seen that with the positive electrode active materials of the Examples, a battery with a high initial discharge capacity and a high capacity retention rate after repeated charge and discharge cycles can be obtained.

What is claimed is:

1. A positive electrode active material, comprising a lithium complex oxide having at least one type of structure selected from an O2 structure, a T#2 structure, or an O6 structure,
wherein, when a total content of metals other than Li and Na is 1, a content of Li is from 0.90 to 1.04, and
in a case in which a ratio of a minimum value Iₘᵢₙ to a maximum value Iₘₐₓ of luminances at local maximums of three consecutive peaks in one-dimensional luminance spectra is calculated in a total of 75 cases, a rate at which the ratio of the minimum value Iₘᵢₙ to the maximum value Iₘₐₓ is 0.3 or less is 2 or fewer among the 75 cases.

2. The positive electrode active material according to claim 1, wherein the positive electrode active material is a compound represented by the following Formula 1: 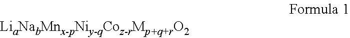
wherein, in Formula 1, a, b, x, y, z, p, q, and r are numbers satisfying 0.9≤a≤1.04, 0≤b≤0.05, x+y+z=1, and 0≤p+q+r≤0.20, and M represents at least one selected from the group consisting of B, Mg, Al, K, Ca, Ti, Cr, Ga, Zr, Nb, Mo, and W.

3. The positive electrode active material according to claim 2, wherein, in X-ray diffraction measurement, a ratio of an intensity I_{Lo} of a peak present in a 2θ range of from 17° to less than 18° to an intensity I_{Hi} of a peak present in a 2θ range of from 18° to less than 19° is less than 5.

4. A positive electrode material, comprising the positive electrode active material of claim 1.

5. A positive electrode layer, comprising the positive electrode material of claim 4.

6. A solid-state battery, comprising the positive electrode active material of claim 1.

7. A method of producing a solid-state battery, the method comprising:
discharging a battery, the battery including a positive electrode layer, a separator, and a negative electrode layer, the positive electrode layer including a lithium complex oxide having at least one type of structure selected from an O₂ structure, a T#2 structure, or an O6 structure, and the negative electrode layer including metallic lithium; and
removing the positive electrode layer from the battery and stacking the removed positive electrode layer, an electrolyte layer or a separator, and a negative electrode layer in this order.
